(19) United States
(12) Patent Application Publication
(10) Pub. No.: US 2013/0204537 A1
(43) Pub. Date: Aug. 8, 2013

(54) Amino Acid Sequence Analyzing Method and Amino Acid Sequence Analyzing Apparatus

(71) Applicant: SHIMADZU CORPORATION, Kyoto-shi (JP)

(72) Inventors: Shigeki KAJIHARA, Uji-shi (JP); Takayuki YOSHIMORI, Nerima-ku (JP); Akiyasu YOSHIZAWA, Kyoto-shi (JP); Naoki KANEKO, Kyoto-shi (JP)

(73) Assignee: SHIMADZU CORPORATION, Kyoto-shi (JP)

(21) Appl. No.: 13/757,439

(22) Filed: Feb. 1, 2013

(30) Foreign Application Priority Data
Feb. 3, 2012 (JP) 2012-021819

(51) Int. Cl. G06F 19/18

(52) U.S. Cl. CPC G06F 19/18
USPC 702/20

(57) ABSTRACT

The amino acid sequence is deduced by using de novo sequencing, to prevent the correct amino acid sequence from not being ranked high as candidates. Amino acid sequence candidates are computed by finding the longest path by a branch and using a bound method based on the spectrum data on the target peptide and the known amino acid sequence. A tree-structured directed graph is used where amino acid sequences are set as nodes and the peak intensities corresponding to the amino acids are set as branches. In a sequence put at a node in the highest layer, an amino acid is placed at a terminal, and as the layer goes deeper, amino acids are sequentially placed from both terminals toward the center of the sequence. The final score is estimated based on the remaining amino acids, and if the score is small, the search is halted.

### TECHNICAL FIELD

The present invention relates to an amino acid sequence analyzing method and an amino acid sequence analyzing apparatus for analyzing an amino acid sequence by mass-analyzing a target sample containing a peptide mixture and deducing the amino acid sequence of a peptide contained in the target sample by using the mass spectrum data obtained from the mass spectrometry.

### BACKGROUND ART

In recent years, structural and functional analyses of proteins have been rapidly promoted as post-genome research. As one method for such structural functional analyses of proteins (proteome analyses), an expression analysis or primary structure analysis of a protein using a mass spectrometer has been widely performed in recent years. In this context, a so-called MSⁿ analysis (where n is an integer equal to or greater than two) in which ions of a specific peak are captured within a quadrupole ion trap and dissociated by collision induced dissociation (CID) or similar process has proven itself to be a powerful technique. In an MS² (=MS/MS) analysis, generally, an ion having a specific mass-to-charge ratio m/z is first selected as a precursor ion from the analysis target. Then, the precursor ion is dissociated by CID. Subsequently, the ions (product ions) generated by the dissociation are mass-analyzed to obtain the information on the mass and the chemical structure of the target ions.

In order to identify the amino acid sequence of a protein by an MSⁿ analysis as previously described, protein is first digested with an appropriate enzyme into a mixture of peptide fragments, and then the peptide fragments are mass-analyzed. Since elements constituting each peptide have stable isotopes with different masses, even peptides having the same amino acid sequence generate a plurality of peaks of different mass-to-charge ratios due to the difference of their isotope composition. The plurality of peaks include: the peak of the ion (main ion) which is composed only of the isotope having the largest natural abundance ratio; and peaks of ions (isotopic ions) including the other isotopes. In the case of a singly-charged ion, these peaks form an isotopic peak group in which the peaks are aligned at the intervals of 1 Da.

Subsequently, from the mass spectrum data of the peptide mixture as previously described, an isotopic peak group originating from one peptide are selected as precursor ions. The precursor ions are dissociated and the ions (product ions) generated thereby are mass-analyzed (MS² analysis). If the precursor ions are not dissociated into sufficiently small fragments by a single dissociation operation, the dissociation operation may be repeated multiple times.

Based on the mass spectrum pattern of the product ions obtained in the manner as just described or that of the precursor ions as previously described, a database search for amino acid sequence identification may be performed by using a search engine such as “MASCOT,” which is a product of Matrix Science Ltd, to determine the amino acid sequence of the target peptide. However, this method cannot be used for new proteins which are not registered in the database. In view of this, a method called “de novo sequencing” is used for deducing the amino acid sequence from a mass spectrum. Roughly speaking, it is a method for deducing the amino acid sequence of a target peptide by searching for the amino acids having a mass-to-charge ratio which corresponds to the difference in the mass-to-charge ratio of a plurality of peaks appearing on the mass spectrum. Search algorithms for this method have been studied in many institutes, and a method using the graph theory, a method using a dynamic programming (see Patent Document 1 and Non-Patent Document 1), and other methods have been developed and proposed.

The key point of the algorithm described in Non-Patent Document 1 is a sandwich algorithm using a “Chummy Pair”, which consists of a specific N-terminal amino acid A and C-terminal amino acid A′. In Non-Patent Document 1, the amino acid sequence of an unknown peptide P to be identified is expressed in a sandwich style, A-a-A′, by using the chummy pair. The deduction of the amino acid sequence comes down to the finding of the peptide that satisfies the relationship of |x+y+//a//−M|≦δ, where x represents the mass-to-charge ratio of an N-terminal amino acid A, //a// that of an amino acid a, y that of a C-terminal amino acid A′, and δ the error boundary. M represents the mass-to-charge ratio obtained by the total mass of the correct amino acids+the mass-to-charge ratio of the N-terminal amino acid (Nterm=H=1.00782 Da)+the mass-to-charge ratio of the C-terminal amino acid (Cterm=OH+H+H=19.0184 Da). Consequently, a plurality of amino acid sequence candidates are found, and they are ordered by a predetermined scoring method.

As such a scoring method, the method described in Non-Patent Document 2 may be used for example. This scoring method uses the scoring function of the following expression:

f(h₁/h)×f(h₂/h)×f(h₃/h)×exp{−[(m′−m)/Δ]²}×log h,

where h denotes the intensity of b-ions or y-ions, h₁ the intensity of the neutral loss ions due to H₂O loss, h₂ the intensity of the neutral loss ions due to NH₃ loss, h₃ the intensity of sub-series ions (where x-ions and z-ions are the sub-series ions of y-ions, and a-ions and c-ions are the sub-series ions of b-ions), m′ the measured mass-to-charge ratio, m the theoretical mass-to-charge ratio, and Δ the tolerance of the measured mass-to-charge ratio m′. That is, in this method, if b-ions or y-ions are present, a bonus point is given to their intensity according to their supporting ions. The function f for providing a bonus point is empirically given.

However, according to a study by the inventors of the present patent application, the probability of deducing the correct amino acid sequence by the aforementioned conventional amino acid sequence deduction method based on Non-Patent Documents 1 and 2 is not always high. One of the reasons is that the correct amino acid sequence may not be included in the candidates found by the dynamic programming as previously described. Another reason is that, even if the correct amino acid sequence is included in the candidates found by the dynamic programming, it may not be always ranked first by the previously described scoring method.

In Patent Document 1, the inventors of the present patent application proposed a method for resolving the disadvantage of the aforementioned conventional dynamic programming method. In the method described in Patent Document 1, in the selection of the amino acid sequence candidates based on mass spectrum data, the problem of finding the amino acid sequence candidate having the highest score which represents the reliability is formulated as a longest path problem on a two-dimensional acyclic graph in which the axis in one direction represents the position in an amino acid sequence and that in the other direction the mass-to-charge ratio on the mass spectrum. Path searches are performed based on the peak list composed of the mass-to-charge ratios and the intensities of the peaks originating from a peptide to be analyzed. Along with this, scores which are the sum of the peak intensities are obtained. Then, paths with a high score are selected and the paths are followed backwards while identifying each amino acid to obtain amino acid sequences.

With the aforementioned modified dynamic programming, in a path search which is initially performed, not only the path having the highest score but a plurality of paths having a high score are selected and the paths are followed backwards to obtain the amino acid sequences. Consequently, multiple amino acid sequence candidates are found. Finding many amino acid sequence candidates in this manner can avoid the possibility that the correct amino acid sequence is not included in the candidates. However, according to a study by the inventors of the present application, the most precise calculations of the scores may not always bring the correct amino acid sequence ranked high. Therefore, the quality of this method is not always sufficient for providing users with the information useful for an amino acid sequence analysis.

### BACKGROUND ART DOCUMENTS

### Patent Document

[Patent Document 1] JP-A 2008-145221

### Non-Patent Documents

[Non-Patent Document 1] Bin Ma et al., “An Effective Algorithm for the Peptide De Novo Sequencing from MS/MS Spectrum”, Symp. Comb. Pattern Matching, 2003, pp. 266-277

[Non-Patent Document 2] Bin Ma et al., “PEAKS: powerful software for peptide de novo sequencing by tandem mass spectrometry”, Rapid Communication of Mass Spectrometry, 17, 20 (2003), pp. 2337-2342

### DISCLOSURE OF THE INVENTION

### Problem to be Solved by the Invention

The present invention has been achieved in view of the aforementioned problems, and the main objective thereof is to make, in a method and apparatus for analyzing an amid acid sequence which use de novo sequencing, the correct amino acid sequence to be ranked high among a plurality of selected amino acid sequence candidates so as to provide users with information useful in performing an analysis.

### Means for Solving the Problem

To solve the aforementioned problem, the first aspect of the present invention provides an amino acid sequence analyzing method for deducing an amino acid sequence of a target sample based on mass spectrum data obtained by a mass spectrometry, including:

a) a peak list creation step, in which a peak list in which mass-to-charge ratios and peak intensities of peaks originating from the target sample are collected is created based on the mass spectrum data;

b) an amino acid sequence candidates determination step, in which a plurality of amino acid sequence candidates are selected by performing a de novo sequencing analysis which uses a search algorithm of branch and bound method, based on data included in the peak list and known information on an amino acid composition of the target sample; and

c) an information displaying step, in which all or part of the amino acid sequence candidates selected in the amino acid sequence candidates determination step are displayed, wherein:

in the amino acid sequence candidates determination step, a selection of amino acid sequence candidates which maximize or increase a score computed by adding intensities of peaks sequentially selected from among the peaks in the peak list is formulated as a problem of finding a longest path and a longer directed path in a tree-structured directed graph with each node being composed of an amino acid sequence in which an amino acid or amino acids are partially placed and with each branch being a peak intensity corresponding to a subsequent amino acid, and, under a constraint condition of a kind and number of amino acids based on the amino acid composition information, a directed path complying with the amino acid composition information is searched in such a manner that an amino acid is placed one by one alternately from one terminal and the other terminal of an amino acid sequence toward a center thereof by using the peak list, and in a case where a peak corresponding to a placeable amino acid does not exist in the peak list, the node is set as an undetermined amino acid and the search is continued, while in a case where an estimated score in a process of the search is small, the search is halted.

The second aspect of the present invention provides an amino acid sequence analyzing apparatus, which is an apparatus for realizing the amino acid sequence analyzing method according to the first aspect of the present invention on a computer, for deducing an amino acid sequence of a target sample based on mass spectrum data obtained by a mass spectrometry, including:

a) a peak list creator for creating, based on the mass spectrum data, a peak list in which mass-to-charge ratios and peak intensities of peaks originating from the target sample are collected;

b) an amino acid sequence candidates determination unit for selecting a plurality of amino acid sequence candidates by performing a de novo sequencing analysis which uses a search algorithm of branch and bound method, based on data included in the peak list and known information on an amino acid composition of the target sample; and

c) an information displayer for displaying all or part of the amino acid sequence candidates selected in the amino acid sequence candidates determination unit, wherein:

in the amino acid sequence candidates determination unit, a selection of amino acid sequence candidates which maximize or increase a score computed by adding intensities of peaks sequentially selected from among the peaks in the peak list is formulated as a problem of finding a longest path and a longer directed path in a tree-structured directed graph with each node being composed of an amino acid sequence in which an amino acid or amino acids are partially placed and with each branch being a peak intensity corresponding to a subsequent amino acid, and, under a constraint condition of a kind and number of amino acids based on the amino acid composition information, a directed path complying with the amino acid composition information is searched in such a manner that an amino acid is placed one by one alternately from one terminal and the other terminal of an amino acid sequence toward a center thereof by using the peak list, and in a case where a peak corresponding to a placeable amino acid does not exist in the peak list, the node is set as an undetermined amino acid and the search is continued, while in a case where an estimated score in a process of the search is small, the search is halted.

The aforementioned “mass spectrum data” are obtained by an MSⁿ analysis in which a target peptide as a precursor ion is dissociated in one or multiple stages and the product ions generated thereby are detected.

The “known information on the amino acid composition of the target sample” is the information on the amino acid composition, i.e. the kind and number of each amino acid, obtained by analyzing the target sample (peptide or protein) using a mass spectrometer or another type of analyzing apparatus for example. If the mass spectrometer is capable of obtaining the mass of the peptide (or protein) of the target sample with very high accuracy, the amino acid composition information can be computed from the mass. The amino acid composition information may be obtained by using an analyzing apparatus such as an LC/MS high-speed amino acid analysis system named “UF-Amino Station,” which is a product of Shimadzu Corporation.

In the amino acid sequence analyzing method and the amino acid sequence analyzing apparatus according to the present invention, the problem of finding the amino acid sequence candidates by using de novo sequencing, i.e. by using the mass-to-charge ratios of the peaks in the peak list, is formulated as a longest path problem on a tree-structured directed graph in which amino acid sequences which contain k amino acids are placed at the nodes in the k^{th} depth. In this process, known amino acid composition information as previously described is used as the constraint condition for the amino acids to be placed. At the first node, which corresponds to the initial setting, an amino acid is placed at one terminal (N-terminal or C-terminal) in an amino acid sequence. Then, with each increment of the depth, amino acids are placed one by one alternately from both terminals toward the center of the sequence. The default terminal and the amino acid placed at this terminal depend on the method for fragmenting protein (such as the kind of a digestive enzyme) in preparing the target sample for example. Hence, they can be determined in accordance with the method.

In the amino acid sequence candidates determination step, based on the peak list which includes the mass-to-charge ratios and intensities of the peaks originating from the target peptide, a path search through the tree structure down to the depth corresponding to the number of amino acids based on the specified amino acid composition is performed to obtain amino acid sequences with a high score which is calculated by adding the peak intensities. In the course of following the tree structure downward as previously described, if a peak whose mass-to-charge ratio corresponds to that of an amino acid which can be placed in the amino acid sequence exists in the peak list, the amino acid may be placed at the node. In the case where there is no such a peak in the list, the node is tentatively labeled as “undetermined,” and the search continues to the subsequent node. In this case, the score is not increased because there is no peak intensity to be added. Since the amino acid composition is known, it is possible to estimate, during the searching process, the range of the score which can be finally obtained based on the remaining amino acids which are placeable in the sequence. If the estimated score is low, the search on the path is halted and another search is performed on a different possible path. Amino acid sequences based on the paths on which relatively high scores have been finally obtained are selected as candidates.

If the score computed in the search is accurate, it is sufficient to consider only the longest path. Actually, however, the candidate with the highest score is not always the correct amino acid sequence. Given this factor, not only the longest path, but second, third, . . . , and k^{th} longest paths are also obtained and the amino acid sequences corresponding thereto are selected as the candidates.

In order to speed up the path search, the computation of the score during the search process should be simple. However, the score obtained by simply summing the peak intensities is not always accurate enough.

Given this factor, the amino acid sequence analyzing method according to the present invention may preferably further include an accuracy computation step, in which, for each of the plurality of amino acid sequence candidates selected in the amino acid sequence candidates determination step, accuracy information which represents an accuracy that the amino acid sequence candidate matches the amino acid sequence of the target sample is computed by using the mass spectrum data, and, in the information displaying step, the amino acid sequence candidates selected in the amino acid sequence candidates determination step are displayed selectively or in an ordered manner based on the accuracy information computed in the accuracy computation step. When the accuracy, i.e. the score, is recomputed in the accuracy computation step, it is preferable to include additional information, such as the intensities of the a-, c-, x-, or z-ions on the mass spectrum, which are different from b-ions or y-ions, and/or the information on the neutral losses.

### EFFECTS OF THE INVENTION

In the amino acid sequence analyzing method and the amino acid sequence analyzing apparatus according to the present invention, even an amino acid sequence which would give a high score in a conventional dynamic programming is passed over for selection as a candidate if it does not conform with the amino acid composition information. In addition, the use of the amino acid composition information as a constraint condition considerably reduces the number of candidates. Therefore, when the obtained candidates are ranked based on their scores, it is highly likely that the correct amino acid sequence candidate is ranked high. Accordingly, it is possible to provide users with reliable information. Further, in the amino acid sequence analyzing method and the amino acid sequence analyzing apparatus according to the present invention, the pruning (the cutting of unnecessary branches) can be appropriately performed based on the estimated score in the search process. This eliminates unnecessary path searches and hence decreases the search time. Therefore, it is possible to find the candidates which include the correct amino acid sequence within an acceptable time.

### BRIEF DESCRIPTION OF THE DRAWINGS

FIG. 1 is block configuration diagram of the amino acid sequence analyzing apparatus according to an embodiment of the present invention.

FIG. 2 is a schematic flowchart of the amino acid sequence analyzing method which is performed by the amino acid sequence analyzing apparatus according to the present embodiment.

FIG. 3 is a diagram in which a peak list created in an analysis example is shown as a mass spectrum.

FIG. 4 shows a part of the tree structure in the present analysis example.

FIGS. 5A and 5B are diagrams for explaining the score estimation during the path search in the present analysis example.

FIGS. 6A and 6B show the amino acid sequence candidates obtained in the present analysis example.

### BEST MODES FOR CARRYING OUT THE INVENTION

Hereinafter, an embodiment of the amino acid sequence analyzing apparatus using the amino acid sequence analyzing method according to the present invention will be described with reference to attached figures.

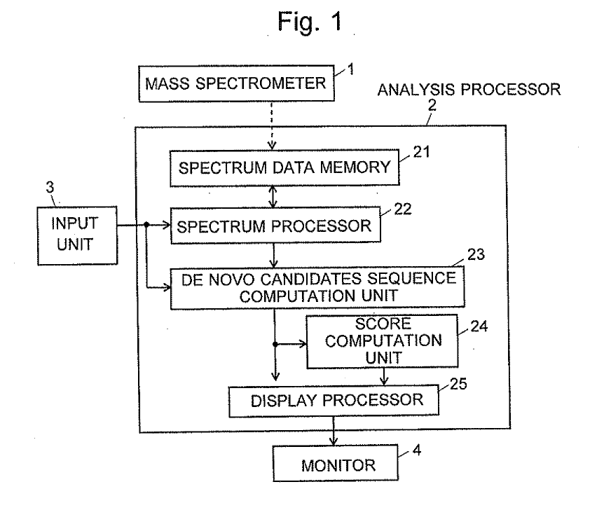

FIG. 1 is a block configuration diagram of the amino acid sequence analyzing apparatus according to the present embodiment. This apparatus is realized by a computer. It is embodied by loading onto the computer an amino acid sequence analyzing program from a removable storage medium (such as a CD-ROM, CD-R, CD-RW, MO, DVD-RAM, or a memory card), a storage medium which is not normally removable such as a hard disk drive (HDD), or other types of storage media, and executing the program on the computer. The program may also be loaded from outside via a communication line.

The apparatus for analyzing amino acid sequence of the present embodiment includes an analysis processor 2, an input unit 3 which is connected to the analysis processor 2, and a monitor 4. The analysis processor 2 includes: a spectrum data memory 21; a spectrum processor 22; a de novo candidates sequence computation unit 23; a score computation unit 24; and a display processor 25. A mass analyzer 1 may be an MSⁿ mass spectrometer such as an MALDI Ion Trap TOFMS, for example. The mass spectrum data obtained by mass-analyzing (MSⁿ analysis) a sample containing a target peptide to be analyzed are stored in the spectrum data memory 21. In the analysis processor 2, an analysis process is performed using the mass spectrum data to deduce the amino acid sequence of the target substance.

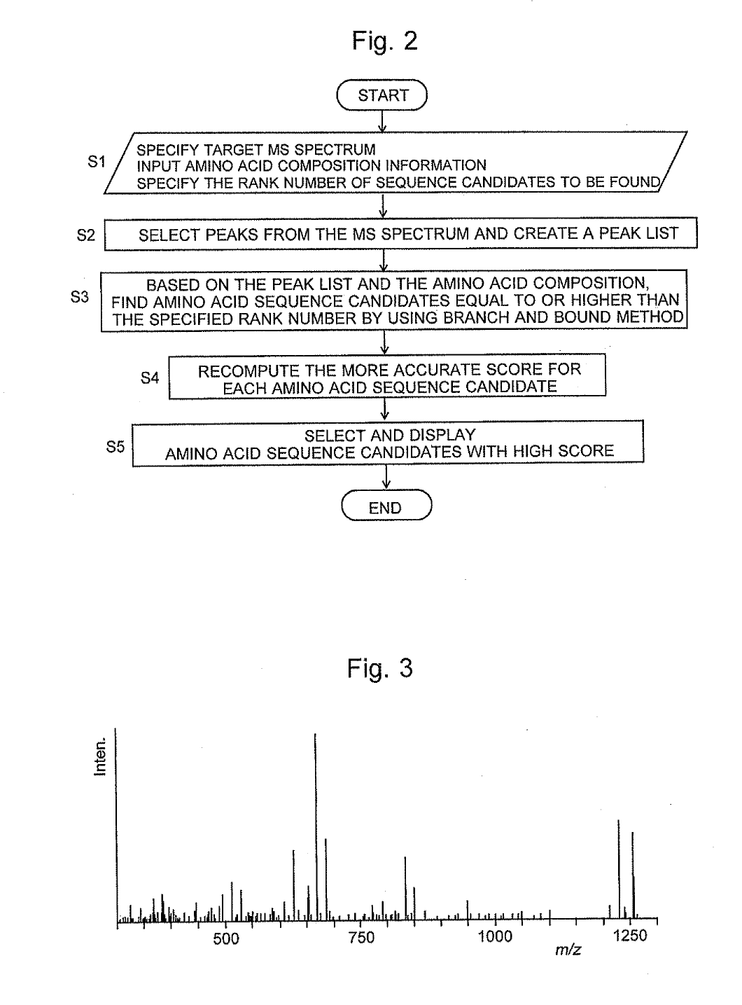

FIG. 2 is a schematic flowchart showing the amino acid sequence analyzing process performed in the analysis processor 2. Hereinafter, an analysis process which is characteristic in the present embodiment will be described, taking an example of an analysis performed based on the data obtained by measuring peptide [LLVVYPWTQR], which is a tryptic digest of hemoglobin.

Prior to performing the analysis, an analyst specifies or provides through the input unit 3 a mass spectrum to be analyzed, amino acid composition information which has been obtained by using an amino acid analyzer or other device, and the rank number of the computed candidates which is required to obtain the correct amino acid sequence (Step S1). The amino acid composition information is only composed of the kind and the number of the amino acids which constitute the peptide. In the present analysis example, the known amino acid composition provided through the input unit 3 is as follows: L (leucine): 2; V (valine): 2; Y (tyrosine): 1; P (proline) :1; W (tryptophan): 1; T (threonine): 1; Q (glutamine): 1; and R (arginine): 1.

The amino acid composition can be obtained, for example, by using an LC/MS high-speed amino acid analysis system named “UF-Amino Station,” which is a product of Shimadzu Corporation. Alternatively, it may be computed from the mass-to-charge ratio of the target peptide obtained by a mass spectrometer having a very high mass accuracy.

In general, many peaks, including noise peaks, appear on a mass spectrum obtained based on mass spectrum data. The spectrum processor 22 selects the peaks originating from the target peptide in the mass spectrum, and creates a peak list composed of the mass-to-charge ratios and intensities of the peaks to be analyzed (Step S2). The selection of peaks in Step 2 can be performed by using the method disclosed in “Robin Gras et al., ‘Improving protein identification from peptide mass fingerprinting through a parameterized multi-level scoring algorithm and an optimized peak detection’, Electrophoresis, 20, pp. 3535-3550 (1999).” In this method, the theoretical values of the intensity ratios of an isotope peak cluster are compared with the measured values. Based on this, undesired peaks of noise are eliminated and the peaks to be analyzed can be selected. The “isotope peak cluster” is a group of peaks originating from ions having the same element composition but having a different mass-to-charge ratio due to the difference in the isotope composition of the ions. Of course, other types of noise elimination methods can be alternatively or additionally used.

FIG. 3 is a diagram in which a peak list created in the present analysis example is shown as a mass spectrum. That is, the peaks existing on the mass spectrum shown in FIG. 3 will be analyzed.

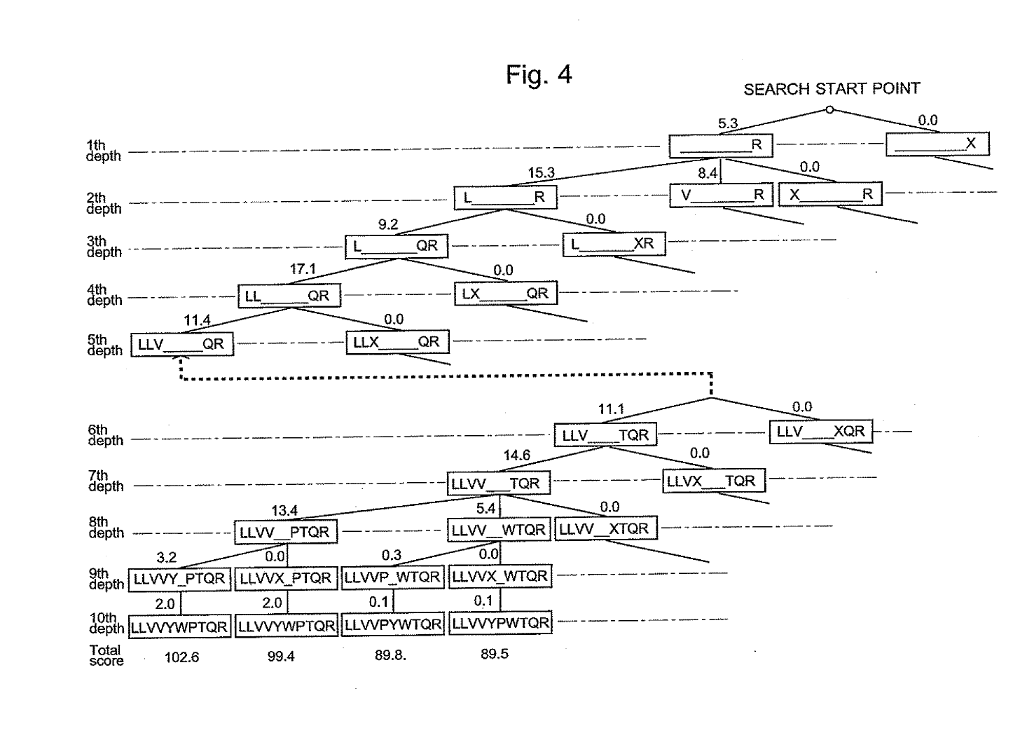

Next, based on the peak list created by the spectrum processor 22 and the amino acid composition information specified through the input unit 3, the de novo candidates sequence computation unit 23 solves the optimization problem of the combination of amino acids by a branch and bound method to find many amino acid sequence candidates (Step S3). As commonly known, the branch and bound method is one of the useful algorithms for solving a combinatorial optimization problem. In the branch and bound method, the longest path is searched for in a directed graph of a multi-layered tree structure in which a plurality of branches diverging from one node are extended to lower layers. In this embodiment, an amino acid sequence in which an amino acid or amino acids (residues) are placed at least partly and the rest is undetermined is placed at each node of the tree structure. The intensity values of the peaks of b-ions or y-ions whose mass-to-charge ratios correspond to those of the amino acids in the peak list are assigned to the branches of the tree structure. The aim of the longest path search is to find an amino acid sequence with a large “score”, which is the sum of the intensity values of the branches that has been passed through while the tree structure is searched from the first to the root to an end of the tree structure, using all the amino acids which correspond to the provided amino acid composition information. FIG. 4 shows a part of the tree structure in the analysis example based on the peak list shown in FIG. 3.

The branch and bound method is composed of two main actions: branching and bounding operations. In order to obtain the solution in a practical computational time, it is important to decrease the number of branches as much as possible in the branching operation and to cut unnecessary branches by the bounding operation before the computation. Given this factor, the innovative algorithm as follows is used taking into account the characteristics of the amino acid sequence and those of the analysis method.

The branching operation is performed by the following procedure. First, an amino acid sequence is put at the first node which corresponds to the initial conditions of the process. That is to say, in this amino acid sequence, an amino acid obtained from the amino acid composition information is placed either at the C-terminal or N-terminal. Which of the N/C terminals is chosen and what amino acid is placed there depend on the method for fragmenting the protein. For example, if the protein is fragmented with a digestive enzyme, they depend on the kind of digestive enzyme. In the present analysis example, trypsin digestion is used. Based on its fragmentation characteristics, arginine (R) or lysine (K) is assigned to the C-terminal of the amino acid sequence which is put at the first node. Since lysine does not exist in the amino acid composition in the present analysis example, arginine is naturally assigned to the C-terminal (in the “1st depth” in FIG. 4). After this assignment, there is no arginine remaining the amino acid composition, so that arginine can no longer be selected as an amino acid.

At each of the nodes in the second depth (“2nd depth” in FIG. 4), which is one layer down from the 1st depth, an amino acid obtained from the amino acid composition information is placed at the other terminal (N-terminal in the analysis example of FIG. 4), which is opposite to the terminal at which an amino acid has just been placed. In the present analysis example, arginine (R) is already assigned at the first node. Therefore, the amino acids remaining in the amino acid composition are the candidates, which are: leucine (L), valine (V), tyrosine (Y), proline (P), tryptophan (W), threonine (T), and glutamine (Q). However, if all the amino acid sequences each of which has one of these amino acids is placed at the N-terminal are used as new nodes, the number of nodes will be too much. In view of this fact, an amino acid sequence or sequences in which the amino acid whose mass-to-charge ratio corresponds to that of a peak in the peak list is placed at the N-terminal are put at the next nodes. The other amino acids whose mass-to-charge ratios do not correspond to that of any peak in the peak list are collectively and provisionally defined as an undetermined amino acid (X). An amino acid sequence with the undetermined amino acid (X) is put at one of the next nodes.

In the analysis example of FIG. 4, two kinds of amino acids, leucine (L) and valine (V), are separately set for different nodes because the peak list includes peaks whose mass-to-charge ratios correspond to those of the two amino acids. The other five kinds of amino acids are collectively set for another node as an undetermined amino acid (X) because the peak list does not include any peak whose mass-to-charge ratio corresponds to any of those of the five amino acids. In this manner, amino acids whose mass-to-charge ratios are not found in the peak list are treated as an undetermined amino acid to decrease the number of branches. In the present analysis example, the use of the undetermined amino acid X reduced the total number of possible branches from 6,236,020 (=10+10×9+10×9×8+ . . . +10×9×8×7×6×5×4×3×2) to 4,299. In the branches from the 1st depth to the 2nd depth in FIG. 4, the peak intensities of 15.3 and 8.4 are respectively given as the scores of the branches of leucine (L) and valine (V) whose mass-to-charge ratios correspond to those of peaks in the mass spectrum, whereas the score of the branch of the undetermined amino acid X is zero.

The bounding operation is performed as follows. As previously described, in the amino acid sequences put at nodes, an amino acid is placed one by one alternately from both terminals of the sequence toward its center as the layer goes deeper: C-terminal→N-terminal→the second position from the C-terminal→the second position from the N-terminal→ . . . . In general, the number of nodes will be enormous if bounding operation is not performed. In light of this, in this embodiment, the mass-to-charge ratios of the amino acid sequences already put at the nodes are used to obtain the range of the mass-to-charge ratios of the remaining peaks to be searched. Then, the score that will be eventually obtained after the path is followed to the end of the tree structure is estimated. In the case where the score is low, in particular, in the case where it is lower than the lowest score of the amino acid sequence candidates which are currently ranked equal to or higher than the rank number specified in Step S1, the search of the current path is halted. In brief, the score which will be finally obtained is estimated in the middle of the search, and the pruning (branch-cutting) is performed based on that score. This can limit the number of paths to be searched and eliminate the unnecessary time for the score computation for the candidates whose final score is low.

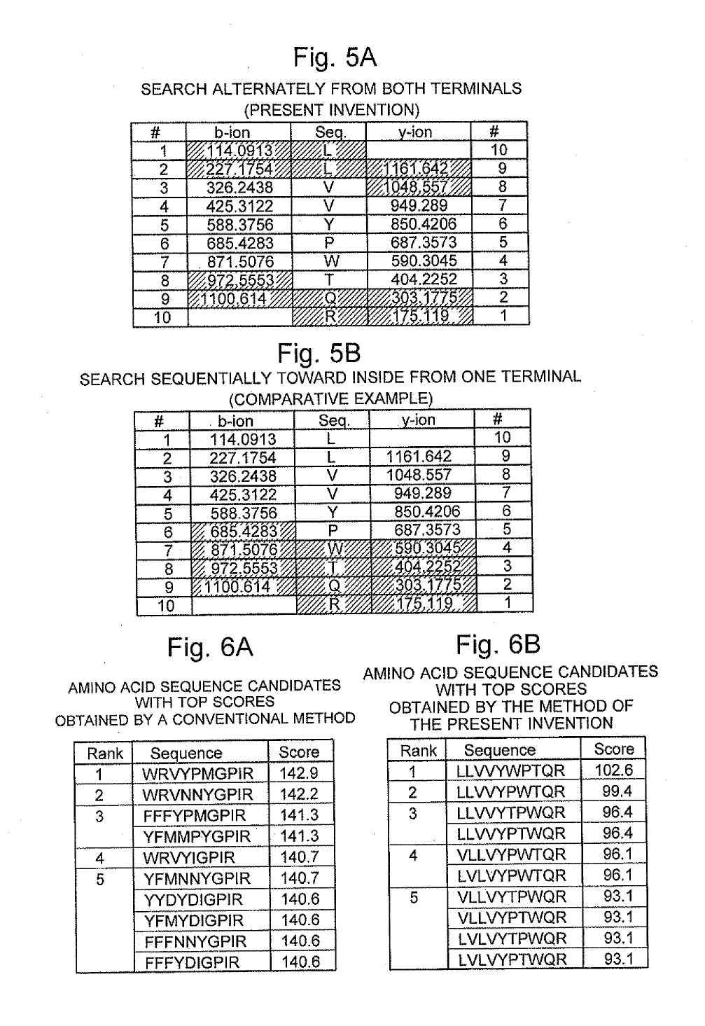

In the example shown in FIG. 4, consider the amino acid sequence [LL******QR] (where * represents a location with no amino acid placed yet) put at a node in the 4th depth. FIGS. 5A and 5B respectively show the theoretical mass-to-charge ratios of b-ions and y-ions for the amino acid sequence in this analysis example. In the table, the hatched portions represent the peaks which have been already allocated. The hatched portions in FIG. 5A represent known theoretical mass-to-charge ratios in the state where four amino acids are placed at both ends of the sequence as in the algorithm of the present embodiment. The hatched portions in FIG. 5B as a comparative example show known theoretical mass-to-charge ratios in the state where four amino acids are sequentially placed from one terminal (C-terminal) of the sequence. Based on the theoretical mass-to-charge ratios of the b-ions and y-ions shown in FIG. 5A, the range of the mass-to-charge ratios of the peaks which correspond to the remaining amino acids at the point in time when the amino acid sequence [LL******QR] is obtained is 227.1754 through 972.5553 for b-ions and 303.1775 through 1048.557 for y-ions. The search range of the peaks which correspond to the remaining amino acid sequences at this point in time is determined to be the widest range of the mass-to-charge ratios of both the b-ions and y-ions. Therefore, the range is set to be between 227.1754 and 1048.557. Within this limited range of mass-to-charge ratios, for the remaining ten peaks to be allocated in this amino acid sequence, the sum of the intensities of top ten peaks in the descending order of the intensity is set to be the estimated scores of the remaining ions.

On the other hand, in the case where four amino acids are sequentially arranged toward the center of the sequence from the C-terminal as shown in FIG. 5B, in the amino acid sequence [******WTQR] which is put at a node in the fourth depth, the mass-to-charge ratios of the remaining b-ions are 685.4283 or less and those of the remaining y-ions are 590.3045 or more. Therefore, in the process of estimating the score, ten peaks are selected in descending order of intensity from among all the peaks within that mass-to-charge ratio range in the peak list. This results in a greater score compared to the aforementioned case. As just described, placing amino acids not from only one terminal of an amino acid sequence but alternately from its both terminals can quickly decrease the value of the estimated score; that is, the estimated score can be quickly brought close to the actual final score. Hence, in the case where the search is fruitless, a search halt, i.e. the pruning, can be performed in an early stage of the process. This can decrease the number of nodes and narrow down the paths to be searched. In the analysis example shown in FIG. 4, the number of nodes actually considered was reduced to 324 from 4,299 as a result of such a characteristic bounding operation.

As previously described, in Step S3, the same number of amino acid sequence candidates as specified by the rank number in Step S1 are finally obtained. Then, the score computation unit 24 recomputes the score for each of the plurality of the amino acid sequence candidates based on the peak list in order to obtain accurate score values (Step S4). This step is performed because, in the aforementioned operation of finding the amino acid sequence candidates, a simplified computation using only peak intensities was performed in order to save time required for the score computation, and the accuracy of the selected amino acid sequence candidates is not sufficient for examination by the analyst. In the score recomputation, the kind of fragment ions with an intensity value to be added to the score may include not only b- and y-ions but a-, c-, x-, and z-fragment ions. Alternatively, some of H₂O/NH₃ neutral losses may be combined to them, and such fragment ions or neutral losses may be appropriately weighted when added. Since the kind of a mass spectrometer characterizes how fragment ions appear, the method of score recomputation may be changed depending on the kind of the used mass spectrometer, the conditions for ion dissociation, or other factors. In addition, in the score recomputation, the difference between an actually measured mass-to-charge ratio and a theoretical one may be taken into consideration, or the intensity pattern of the fragments obtained from the amino acid sequence may be taken into account.

The display processor 25 selects a predetermined number of reliable amino acid sequence candidates based on the accurate score values computed by the score computation unit 24, and displays them with their score values in a window of the monitor 4 (Step S5). Of course, all the amino acid sequence candidates can be displayed in descending order of their score. In this case, it is preferable to also display the relationship between the analyzed mass spectrum and the deduced amino acid sequence candidates.

FIG. 6A shows the top ten amino acid sequence candidates obtained by using a conventional method for the data of the aforementioned analysis example. In this result, the correct amino acid sequence [LLVVYPWTQR] is not present among the top ten candidates. FIG. 6B shows the top ten amino acid sequence candidates obtained by the algorithm of the amino acid sequence analyzing apparatus according to the present embodiment which was described earlier. In this case, the correct amino acid sequence is ranked second. Therefore, the amino acid sequence deduction using the previously described characterizing algorithm can increase the possibility that the correct amino acid sequence is included among the top candidates. As a consequence, it is possible to provide the analyst with reliable information.

It should be noted that the embodiment described thus far is merely an example of the present invention, and it is evident that any modification, adjustment, or addition appropriately made within the spirit of the present invention is also included in the scope of the claims of the present application.

### Explanation of Numerals

1 . . . Mass Analyzer
2 . . . Analysis Processor
21 . . . Spectrum Data Memory
22 . . . Spectrum Processor
23 . . . De Novo Candidates Sequence Computation Unit
24 . . . Score Computation Unit
25 . . . Display Processor
3 . . . Input Unit
4 . . . Monitor

1. An amino acid sequence analyzing method for deducing an amino acid sequence of a target sample based on mass spectrum data obtained by a mass spectrometry, comprising:
a) a peak list creation step, in which a peak list in which mass-to-charge ratios and peak intensities of peaks originating from the target sample are collected is created based on the mass spectrum data;
b) an amino acid sequence candidates determination step, in which a plurality of amino acid sequence candidates are selected by performing a de novo sequencing analysis which uses a search algorithm of branch and bound method, based on data included in the peak list and known information on an amino acid composition of the target sample; and
c) an information displaying step, in which all or part of the amino acid sequence candidates selected in the amino acid sequence candidates determination step are displayed, wherein:
in the amino acid sequence candidates determination step, a selection of amino acid sequence candidates which maximize or increase a score computed by adding intensities of peaks sequentially selected from among the peaks in the peak list is formulated as a problem of finding a longest path and a longer directed path in a tree-structured directed graph with each node being composed of an amino acid sequence in which an amino acid or amino acids are partially placed and with each branch being a peak intensity corresponding to a subsequent amino acid, and, under a constraint condition of a kind and number of amino acids based on the amino acid composition information, a directed path complying with the amino acid composition information is searched in such a manner that an amino acid is placed one by one alternately from one terminal and the other terminal of an amino acid sequence toward a center thereof by using the peak list, and in a case where a peak corresponding to a placeable amino acid does not exist in the peak list, the node is set as an undetermined amino acid and the search is continued, while in a case where an estimated score in a process of the search is small, the search is halted.

2. The amino acid sequence analyzing method according to claim 1, further comprising an accuracy computation step, in which, for each of the plurality of amino acid sequence candidates selected in the amino acid sequence candidates determination step, accuracy information which represents an accuracy that the amino acid sequence candidate matches the amino acid sequence of the target sample by using the mass spectrum data is computed, wherein:
in the information displaying step, the amino acid sequence candidates selected in the amino acid sequence candidates determination step are displayed selectively or in an ordered manner based on the accuracy information computed in the accuracy computation step.

3. An amino acid sequence analyzing apparatus for deducing an amino acid sequence of a target sample based on mass spectrum data obtained by a mass spectrometry, comprising:
a) a peak list creator for creating, based on the mass spectrum data, a peak list in which mass-to-charge ratios and peak intensities of peaks originating from the target sample are collected;
b) an amino acid sequence candidates determination unit for selecting a plurality of amino acid sequence candidates by performing a de novo sequencing analysis which uses a search algorithm of branch and bound method, based on data included in the peak list and known information on an amino acid composition of the target sample; and
c) an information displayer for displaying all or part of the amino acid sequence candidates selected in the amino acid sequence candidates determination unit, wherein:
in the amino acid sequence candidates determination unit, a selection of amino acid sequence candidates which maximize or increase a score computed by adding intensities of peaks sequentially selected from among the peaks in the peak list is formulated as a problem of finding a longest path and a longer directed path in a tree-structured directed graph with each node being composed of an amino acid sequence in which an amino acid or amino acids are partially placed and with each branch being a peak intensity corresponding to a subsequent amino acid, and, under a constraint condition of a kind and number of amino acids based on the amino acid composition information, a directed path complying with the amino acid composition information is searched in such a manner that an amino acid is placed one by one alternately from one terminal and the other terminal of an amino acid sequence toward a center thereof by using the peak list, and in a case where a peak corresponding to a placeable amino acid does not exist in the peak list, the node is set as an undetermined amino acid and the search is continued, while in a case where a estimated score in a process of the search is small, the search is halted.

4. The amino acid sequence analyzing apparatus according to claim 3, further comprising an accuracy computation unit for computing, for each of the plurality of amino acid sequence candidates selected in the amino acid sequence candidates determination unit, accuracy information which represents an accuracy that the amino acid sequence candidate matches the amino acid sequence of the target sample by using the mass spectrum data, wherein:
the information displayer displays the amino acid sequence candidates selected in the amino acid sequence candidates determination unit selectively or in an ordered manner based on the accuracy information computed by the accuracy computation unit.
